(19) United States
(12) Patent Application Publication
(10) Pub. No.: US 2018/0301126 A1
(43) Pub. Date: Oct. 18, 2018

(54) Miniature Interactive Drummer Kit

(71) Applicant: Marlan Bell, Tualatin, OR (US)

(72) Inventor: Marlan Bell, Tualatin, OR (US)

(21) Appl. No.: 15/952,184

(22) Filed: Apr. 12, 2018

Related U.S. Application Data
(60) Provisional application No. 62/484,660, filed on Apr. 12, 2017.

(51) Int. Cl. G10D 13/02; G10H 3/14

(52) U.S. Cl. CPC G10D 13/02; G10H 2230/281; G10H 3/146

(57) ABSTRACT

A miniature interactive drummer kit. Once assembled the miniature drummer kit is to be left out as an interactive display piece. The kit includes a base member on which a multi-piece drum set, and a multi-piece cymbal set are removably mounted, such that elements of both sets can intermix to give rise to numerous unique configurations. The kit also includes several finger operated switches and pedals that can be used to used to simulate the act of playing drums on the miniature drum set. Furthermore, a microcontroller unit is embedded in the base member and can be used to synchronize audio outputs from one or more speakers mounted on the base member with user generated drum beats from the finger operated pedals, and lighting effects from several light sources embedded in the base member and drum set.

### CROSS REFERENCE TO RELATED APPLICATION

This application claims the benefit of U.S. Provisional Application No. 62/484,660 filed on Apr. 12, 2017. The above identified patent application is herein incorporated by reference in its entirety to provide continuity of disclosure.

### BACKGROUND OF THE INVENTION

The present invention relates to interactive miniature desktop ornaments for music enthusiasts, specifically for persons who enjoy playing jazz-style drum sets.

Miniature desktop ornaments are normally non-functional devices that only have aesthetic value. However, most persons who are musically inclined are more interested in playing an instrument than in appreciating the instrument's visual aesthetic qualities. The present invention provides an interactive miniature desktop ornament in the form of a drum set that can be played with finger operated pedals, and further includes audio-visual effects that synchronize a light show, audio outputs and user generated drum beats.

Devices have been disclosed in the known art that relate to interactive miniature musical desktop ornaments. However, these devices have several known drawbacks. For example, these devices do not provide finger operated pedals that can be used to play an instrument, nor do they include coordinated audio playback and lighting effects.

In light of the devices disclosed in the known art, it is submitted that the present invention substantially diverges in design elements from the known art and consequently it is clear that there is a need in the art for an improvement to existing interactive miniature musical ornaments. In this regard the instant invention substantially fulfills these needs.

### SUMMARY OF THE INVENTION

In view of the foregoing disadvantages inherent in the known types of interactive miniature musical ornaments now present in the known art, the present invention provides a new configuration for finger operated musical instruments wherein the same can be utilized for providing convenience for the user when interacting with a miniature musical ornament.

It is another object of the present invention to provide reconfigurable assembly kit for a miniature interactive drum set scaled down to ⅛^{th} of actual size.

Another object of the present invention is to provide finger operated switches that can be used to play a miniaturized musical instrument.

Yet another object of the present invention is to provide an ornament with interactive audio playback and lighting synchronized with finger operated switches that can be used to play a miniaturized musical instrument.

Yet still another object of the present invention is to provide a microcontroller unit that can be used to control the illumination of light sources and the audio output from speakers embedded in a desktop ornament to create a synchronized audio-visual effect.

A further object of the present invention is to provide a microcontroller unit that can be remotely operated through a smart phone or computer application

An additional object of the present invention is to provide a full multi-piece miniature drum set that has the look and feel of a traditional jazz style drum set.

Another object of the present invention is to provide a housing for more functional items like a clock, a security camera, a photo display, or a movie projector.

Another object of the present invention is to provide an assembly kit for a miniature interactive drum set that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a miniature interactive drummer kit.

FIG. 2 shows a block diagram of the electronic components of an embodiment of the miniature interactive drummer kit.

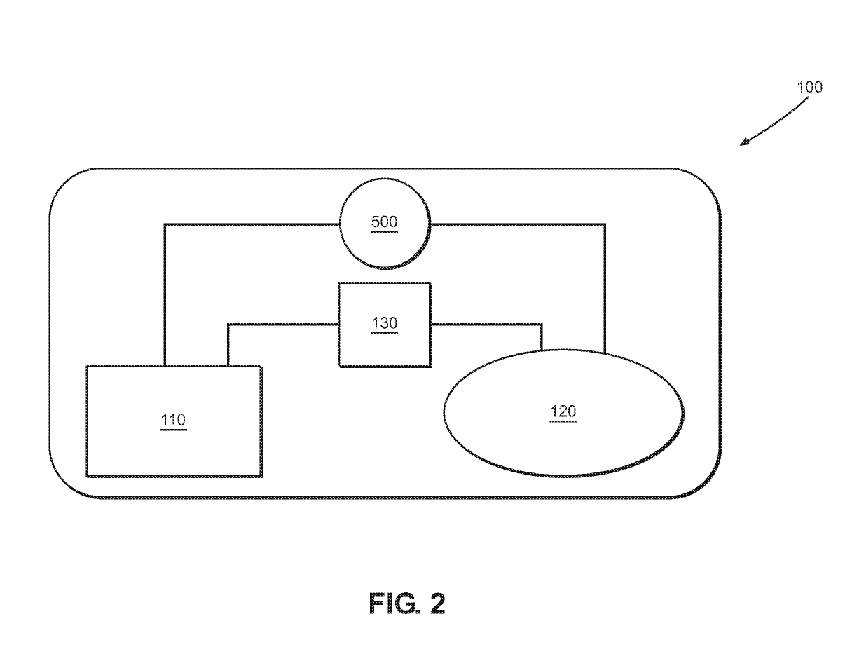

FIG. 3 shows another perspective view of an embodiment of the miniature interactive drummer kit.

FIG. 4 shows a perspective view of three different embodiments of switches used in an embodiment of the miniature interactive drummer kit.

FIG. 5 shows a perspective view of a switch in use striking a miniature representation of a bass drum instrument in an embodiment of the miniature interactive drummer kit.

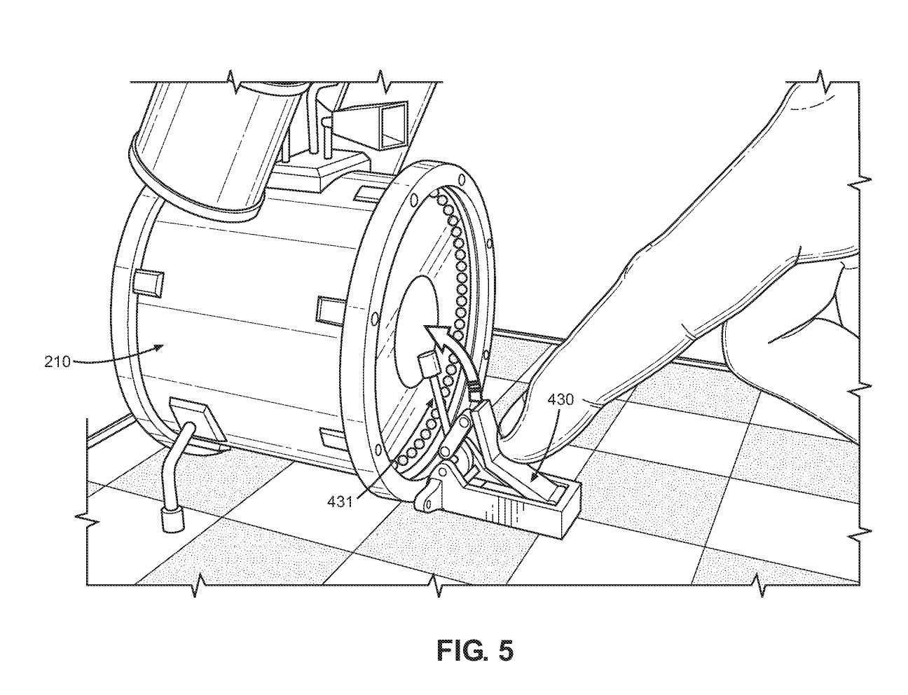

FIG. 6 shows a side-by-side perspective view of an embodiment of an assembly kit for a miniature interactive drum set facing in opposite directions.

### DETAILED DESCRIPTION OF THE INVENTION

Reference is made herein to the attached drawings. Like reference numerals are used throughout the drawings to depict like or similar elements of the miniature interactive drummer kit. For the purposes of presenting a brief and clear description of the present invention, the preferred embodiment will be discussed as used for assembly kit for a miniature interactive drummer kit. The figures are intended for representative purposes only and should not be considered to be limiting in any respect.

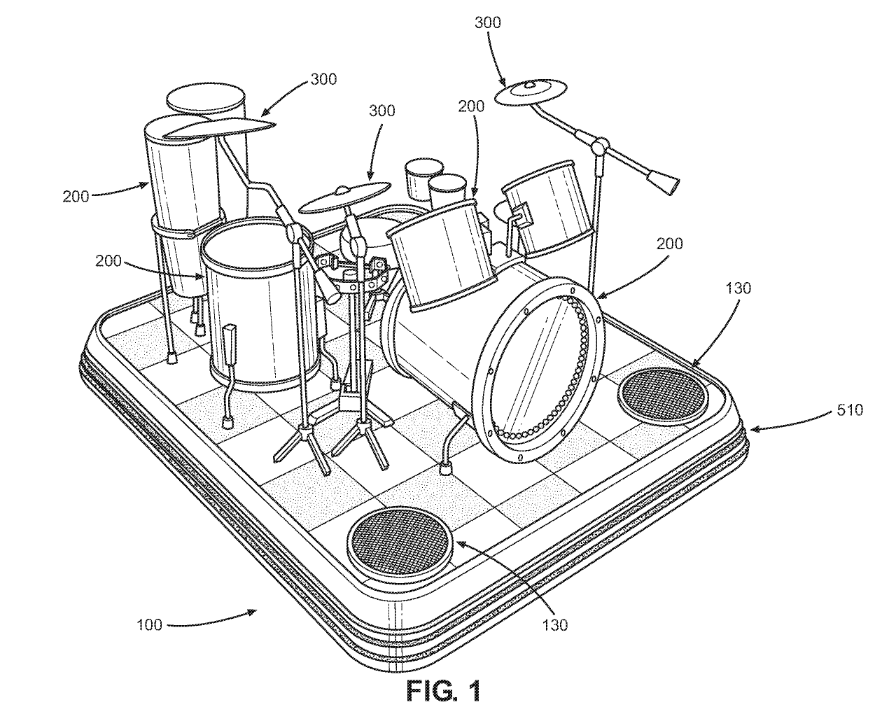

Referring now to FIGS. 1 & 2, there are shown a perspective view of an embodiment of a miniature interactive drummer kit and a block diagram of the electronic components of an embodiment the miniature interactive drummer kit, respectively. The miniature interactive drummer kit 1000 comprises a multi-piece drum set 200 and a multi-piece cymbal set 300 that are removably mounted on a base member 100, such that individual components from both the drum set 200 and the cymbal set 300 can be mounted together in a variety of unique combination and configurations. The individual components from both the drum set 200 and the cymbal set 300 include scaled miniature representation of a musical instrument. The individual components from both the drum set 200 and the cymbal set 300 are removably secured to the base 100 via a fastener, such as friction fit members, glue, magnets, and the like.

Additionally, in one embodiment the multi-piece drum set 200 and multi-piece cymbal set 300 are shaped and proportioned to be ⅛th of actual size, and the base member 100 further includes a microcontroller unit 110 and a removeable power supply 120 that is configured to provide power to all electrical components connected to the base member 100.

In the illustrated embodiment the microcontroller unit 110 is operably connected to the power supply 120, one or more speakers 130 mounted on the base member 100 and to the plurality of light sources 510 disposed along the outer perimeter of the base member 100, such that the microcontroller unit 110 is configured to control the illumination of the light sources 510 and the audio output from the speakers 130 to create a synchronized audio-visual effect. Furthermore, the power supply 120 is operably connected to the microcontroller unit 110, the speakers 130, and a plurality of light sources 510, 520, 530.

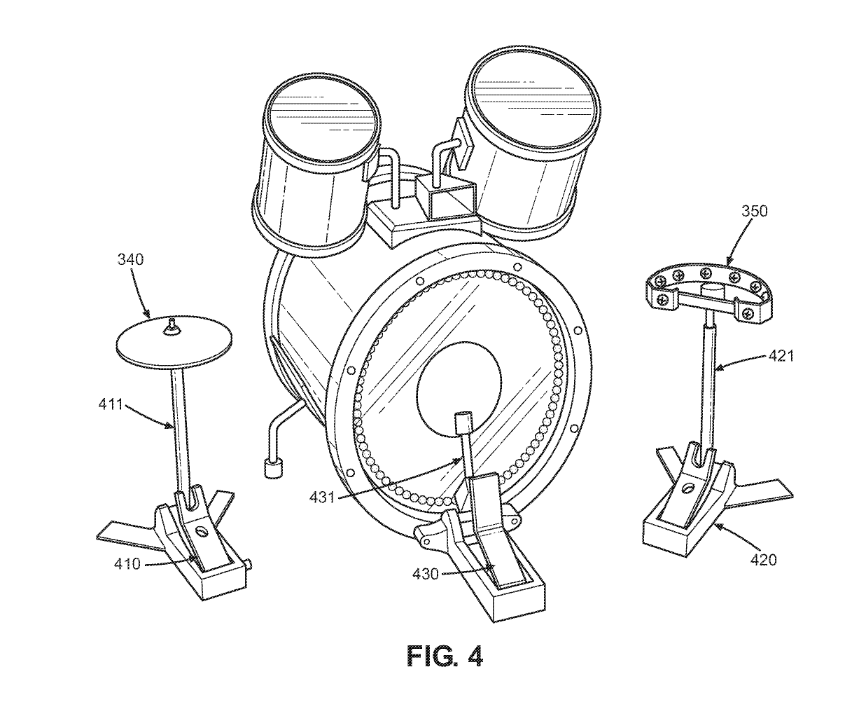

More specifically, the microcontroller unit 110 can be used to playback a drum sequence audio data and to control the intensity and timing of the illumination of light sources 510, such that each pulse of light and sound coincide with a drum beat from a user operating a switch 410, 420, or 430 (shown and discussed further in FIGS. 4 & 5). In one embodiment, the drum sequence audio data is a portion of a song stored on non-transitory memory of the base. In alternative embodiments, the drum sequence audio data is stored on a network accessible by the present invention. In yet another embodiment, the base member includes a microphone configured to record a musical portion of a song and create the drum sequence audio data to be played back via the speakers 130. The microcontroller unit 110 combines user generated drumbeats from the switches (see FIGS. 4 & 5), audio playback from the speakers 130, and lighting effects from light sources 510, 520, 530 to create an immersive and interactive user experience. In other embodiments, the microcontroller unit 110 is also configured to connect to the internet such that it can be remotely operated by means of a smartphone or computer application.

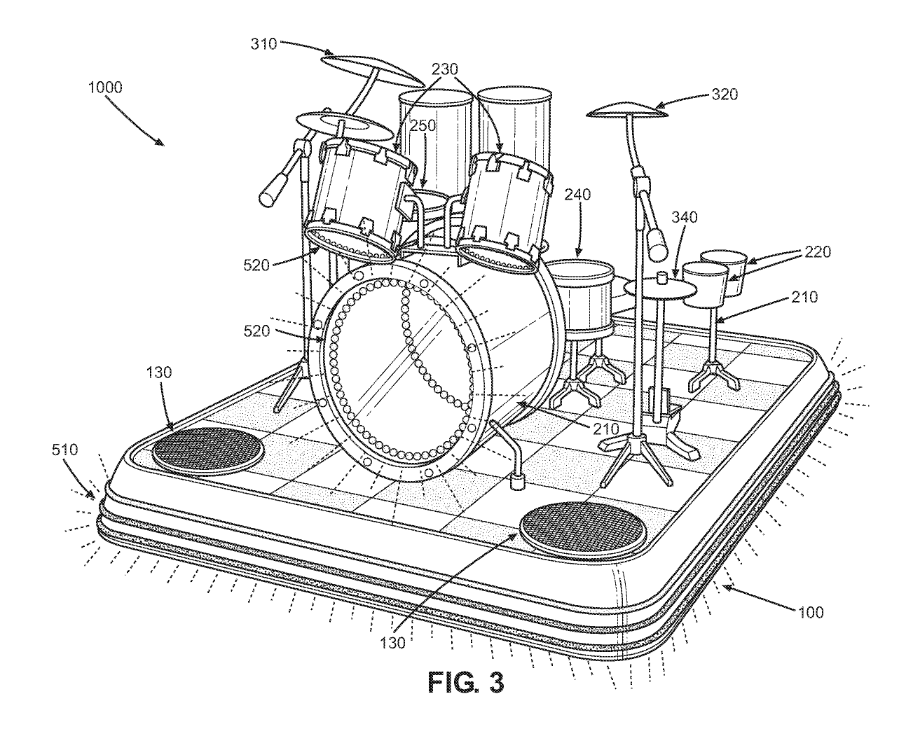

Referring now to FIG. 3, there is shown another perspective view of an embodiment of the miniature interactive drummer kit. In the illustrated embodiment the drum set 200 includes one or more bass drums 210, one or more small rack tom drums 220, one or more large rack tom drums 230, one or more floor tom drums 240, and one or more snare drums 250, such that the multi-piece drum set 200 is configured to have the look and feel of a traditional jazz style drum set. While the cymbal set 300 includes one or more ride cymbals 310, one or more crash cymbals 320, one or more splash cymbals 330, and one or more hi-hat cymbals 340. Furthermore, in addition to the light sources 510 along the perimeter of base member 100, the assembly kit 1000 also includes, light sources 520 embedded within one or more elements of the drum set 200 and light sources 530 disposed along the outer perimeter of the speakers 130 on base member 100. In one embodiment, a light source of the plurality of light source 510, 520, 530 is paired to a particular scaled miniature representation of the musical instrument of either the drum set 200 and the cymbal set 300, wherein the corresponding light source is configured to illuminate and synchronize with an actuation of the switch operably connected to the particular scaled miniature representation of the musical instrument of the drum set 200 and the cymbal set 300. In yet another embodiment, a corresponding light source of the plurality of lights 510, 520, 530 is paired to a particular musical instrument of the drum sequence audio data, wherein the corresponding light source is configured to illuminate and synchronize with an audio playing of the drum sequence audio data.

Referring now to FIGS. 4 & 5, there are shown perspective views of three embodiments of switches used in an embodiment of the miniature interactive drummer kit, and a perspective view of a switch in use striking a bass drum in an embodiment of an assembly kit for a miniature interactive drum set respectively. The switches 410, 420, 430 are configured to allow one or more fingers to actuate any element of the miniaturized multi-piece drum set 200, or any element of the miniaturized multi-piece cymbal set 300 to simulate the act of playing drums. In the illustrated embodiment a first switch 410 is operably connected to a hi-hat cymbal 340, such that upon pressing down on the switch 410 a tubular housing 411 is launched upwards to strike the hi-hat symbol and produce a clashing sound effect. Similarly, a second switch 420 is operably connected to a tambourine cymbal 350, such that upon pressing down on the switch 410 a tubular housing 411 is launched upwards to strike the tambourine symbol and produce a jingling sound effect. A third switch 430 is operably connected to a bass drum 210, such that when a finger presses down on the switch 430 a lever arm 431 rotates away from the bass drum 210 and upon releasing the switch 430 the lever arm 431 snaps back to strike the bass drum 210 to produce a booming sound effect.

More generally, switches 410, 420 for elements of the cymbal set 300 utilize the quick upward motion of a tubular housing 411, 421 towards a cymbal 300 to generate sound effects. While switch 430 for elements of the drum set 200 utilize a two-step process of first rotating a lever arm 431 away and then allowing the lever arm 431 to quickly snap back toward the drum element 200 to generate sound effects. In other embodiments the switches 410, 420, and 430 are used in combination with other elements of the drum set 200 and other elements of the cymbal set 300 based on the user's preference.

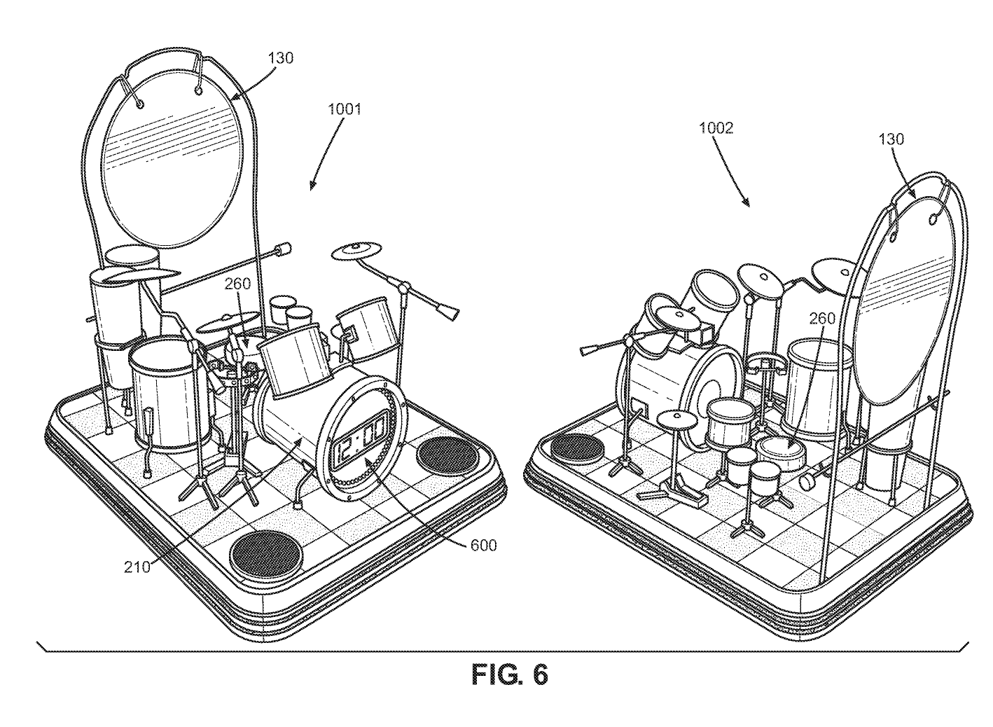

Referring now to FIG. 6, there are shown two perspective views of an embodiment of the miniature interactive drummer kit facing in opposite directions. In the forward-facing miniature interactive drummer kit 1001 a clock 600 is disposed within the bass drum 210 to add more functionality and value to the desktop ornament 1001. Additionally, both the forward-facing assembly kit 1001, and the backward facing miniature interactive drummer kit 1002 include gong style cymbals 130 and a seat for the drummer 260. Other embodiments include a variety of add-on features similarly disposed in the body of the bass drum 210. For example, a home surveillance camera would be well hidden if similarly installed within the bass drum 210. More add-ons include a digital photo display or a movie projector.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A miniature interactive drummer kit, comprising:
a base member including a drum set and a cymbal set each removably mounted thereto, wherein the drum set and the cymbal set includes a scaled miniature representation of a musical instrument;
a switch operably connected to the drum set or the cymbal set, the switch configured to allow finger actuation of each the drum set or the cymbal set to simulate the playing thereof;
a plurality of light sources configured to illuminate upon actuation of the switch;
wherein the plurality of light sources are configured to illuminate and synchronize with a drum sequence audio data, the drum sequence audio data being a musical portion of a song.

2. The miniature interactive drummer kit of claim 1, further comprising a speaker configured to play the drum sequence audio data.

3. The miniature interactive drummer kit of claim 2, wherein a microcontroller unit is configured to govern the plurality of light sources and the speaker to create a synchronized audio-visual display.

4. The miniature interactive drummer kit of claim 3, wherein the microcontroller unit can be remotely operated by an electronic device.

5. The miniature interactive drummer kit of claim 1, wherein each light source of the plurality of light sources is paired to a particular scaled miniature representation of the musical instrument of either the drum set and the cymbal set, wherein the corresponding light source is configured to illuminate and synchronize with an actuation of the switch operably connected to the particular scaled miniature representation of the musical instrument of the drum set and the cymbal set.

6. The miniature interactive drummer kit of claim 1, wherein each light source of the plurality of light sources is paired to a particular musical instrument of the drum sequence audio data, wherein the corresponding light source is configured to illuminate and synchronize with an audio playing of the drum sequence audio data.

7. The miniature interactive drummer kit of claim 1, wherein the drum set and the cymbal set are reconfigurably mounted on the base.

8. The miniature interactive drummer kit of claim 1, wherein the drum set represents scaled miniature representation of a musical instrument from at least one of: a bass drum, a small rack tom drum, a large rack tom drum, a floor tom drum, and a snare drum.

9. The miniature interactive drummer kit of claim 1, wherein the cymbal set represents a scaled miniature representation of musical instrument from at least one of: a ride cymbal, a crash cymbal, a splash cymbals, and a hi-hat cymbals.

10. The miniature interactive drummer kit of claim 1, wherein actuation of the switch causes production of sound from the corresponding drum set or cymbal set.

11. The miniature interactive drummer kit of claim 1, wherein the drum sequence audio data is stored on a non-transitory memory of the base.

12. The miniature interactive drummer kit of claim 1, wherein the drum sequence audio data is stored on a wireless network.

13. The miniature interactive drummer kit of claim 1, wherein the base further comprises a microphone, the microphone configured to record a drum sequence audio data.

14. The miniature interactive drummer kit of claim 1, wherein the base further comprises a clock embedded in a face thereof.

15. The miniature interactive drummer kit of claim 1, wherein the base further comprises a camera embedded in a face thereof.

16. The miniature interactive drummer kit of claim 1, wherein the base further comprises a digital display embedded in a face thereof.

17. The miniature interactive drummer kit of claim 1, wherein the base further comprises a projector embedded in a face thereof.

18. The miniature interactive drummer kit of claim 1, wherein the plurality of lights are disposed along a perimeter of the base.
